(19) United States
(12) Patent Application Publication
(10) Pub. No.: US 2024/0217318 A1
(43) Pub. Date: Jul. 4, 2024

(54) RETRACTABLE ANTI-GLARE SUN SCREEN

(71) Applicants: Brenda K. Sharkey, Peoria, AZ (US); D. Bruce Howden, Peoria, AZ (US)

(72) Inventors: Brenda K. Sharkey, Peoria, AZ (US); D. Bruce Howden, Peoria, AZ (US)

(21) Appl. No.: 18/330,437

(22) Filed: Jun. 7, 2023

Related U.S. Application Data
(60) Provisional application No. 63/477,572, filed on Dec. 29, 2022.

(51) Int. Cl. B60J 3/02; B60J 3/06

(52) U.S. Cl. CPC B60J 3/0208; B60J 3/06

(57) ABSTRACT

A sun screen for a vehicle comprises at least one extendable and retractable panel. The panel may be manually operated or electrically operated. Via use of the system, glare may be reduced for a vehicle occupant.

### CROSS-REFERENCE TO RELATED APPLICATIONS

This application claims priority to, and the benefit of, U.S. Provisional Patent Application Ser. No. 63/477,572 filed Dec. 29, 2022, entitled “RETRACTABLE ANTI-GLARE SUN SCREEN”, the entire contents of which are incorporated herein by reference in their entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to shading, and more particularly, to automotive shading devices having extendable portions.

### BACKGROUND

Sun glare is an ongoing challenge for automobile users. Accordingly, improved devices and techniques for reducing or managing sun glare remain desirable.

### SUMMARY

An anti-glare sun screen may comprise at least one extendable and retractable panel of glare-reducing material. The panel may be coupled to the sun visor of an automobile or integrated into a sun visor for use on an automobile.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a sun screen in accordance with an exemplary embodiment.

FIG. 2A illustrates a sun screen in accordance with an exemplary embodiment.

FIG. 2B illustrates a side view of a sun screen in accordance with an exemplary embodiment.

FIG. 3 illustrates a sun screen wherein the sun screen is extended, in accordance with an exemplary embodiment.

FIG. 4 illustrates an inner view of an embodiment of a sun screen wherein the sun screen panel is retracted, in accordance with an exemplary embodiment.

FIG. 5 illustrates an inner view of a sun screen wherein the sun screen panel is extended, in accordance with an exemplary embodiment.

FIG. 6 illustrates a motorized sun screen wherein the sun screen panel is retracted, in accordance with an exemplary embodiment.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical structural, materials, or mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

In the context of the present disclosure, methods, systems, and articles may find particular use in connection with automobiles. However, various aspects of the disclosed embodiments may be adapted for performance in a variety of other systems, including internal combustion heavy-duty commercial vehicles, internal combustion or electric medium-duty vehicles, passenger vehicles, off-road vehicles, trains, watercraft, aircraft, or any other mobile or stationary system where sun glare may be an issue. As such, numerous applications of the present disclosure may be realized.

A sun screen 100 may be coupled to a vehicle visor that comprises one or more panels made of a light-reducing or glare-reducing material (such as polycarbonate, tempered class, or the like). The sun screen 100 comprising a panel or panels may be coupled to (or comprise a portion of) a vehicle visor of an automobile. Sun screen 100 may be original equipment on an automobile; alternatively, sun screen 100 may be a retrofit or add-on component to an existing automobile. The sun screen 100 may be integrated in a vehicle visor or may be removably coupled to a vehicle visor.

The panel or panels of the sun screen 100 may be extended and retracted, for example in order to reduce glare for a driver or other vehicle occupant. The panel or panels of the sun screen 100 may be manually operated (for example via a sliding mechanism, gears, ratchets, levers, and/or any other suitable manual components) or electrically operated. In various embodiments, where the panel or panels of the sun screen 100 is/are electrically operated, the sun screen 100 may comprise suitable gears, electric motors, integrated circuits, power supplies or interfaces, and/or the like. Moreover, control circuitry for sun screen 100 (for example, switches, buttons, integrated circuits, and/or the like) may be placed on or in a vehicle visor, overhead console, key fob, dashboard, driver and/or passenger door, central control pod, and/or any other suitable location in a vehicle. A sun screen 100 may be sized and shaped to be compatible with a particular vehicle sun visor and/or windshield or window; alternatively, a particular sun screen 100 may be configured to be compatible with a plurality of vehicles.

In some exemplary embodiments, sun screen 100 comprises a single panel or layer. In other exemplary embodiments, sun screen 100 comprises multiple panels or layers which may overlap in a stored/retracted position but at least partially extend past one another in an extended position (i.e., a telescoping or similar manner), in order to provide an increased area for glare reduction or shading.

In various exemplary embodiments, a method comprises coupling a sun screen 100 to an existing vehicle sun visor. The method may further comprise extending a panel of the sun screen to provide glare reduction for a vehicle occupant. The method may further comprise retracting the panel of the sun screen, when desired, to allow for storage of the sun screen.

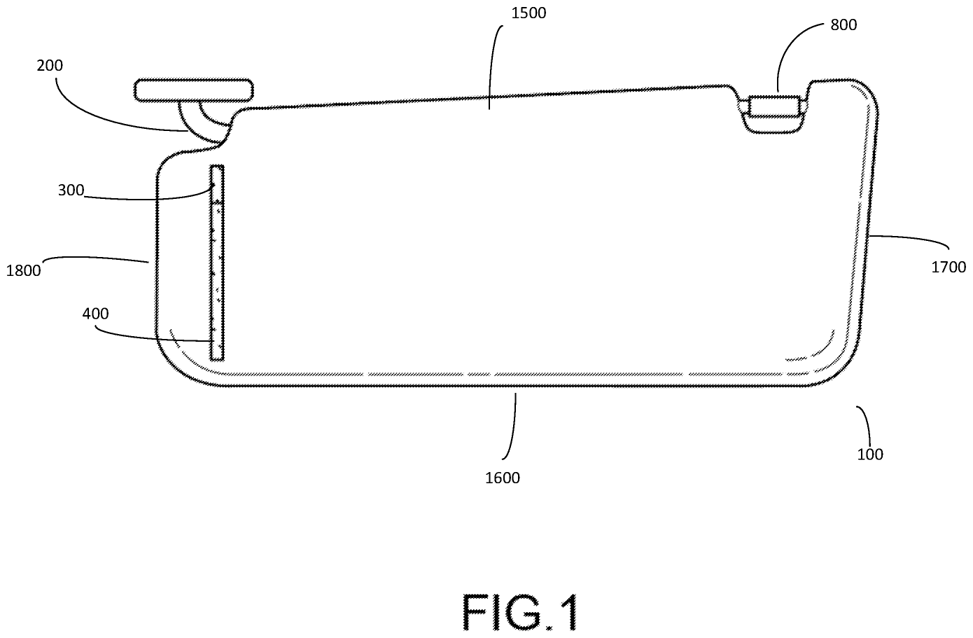

In various embodiments, a sun screen 100 is coupled to a vehicle. The sun screen 100 may be positioned above the driver's seat of a vehicle to prevent a driver's vision from being impaired by glare while operating the vehicle. The vehicle visor may be a custom visor installed in a vehicle. In various embodiments, the sun screen may attach to an existing visor with which a vehicle is manufactured and sold. Referring to FIG. 1, the sun screen 100 may be coupled to a vehicle using a vehicle visor hinge 200, wherein the sun screen 100 may move about the vehicle visor hinge 200 for ideal placement of the sun screen 100 based on the positioning of the sun or light source relative to the driver and passengers in the car.

Vehicle visor hinge 200 may movably couple the sun screen 100 to the roof of a vehicle. The vehicle visor hinge 200 may allow the vehicle visor to swing toward the driver's side door of a vehicle. In various embodiments, the vehicle visor hinge 200 may be removably coupled to the vehicle. In various embodiments, the vehicle visor hinge 200 may be permanently coupled to the vehicle. In various embodiments the vehicle visor hinge 200 may be on the top left side of the sun screen 100. In various embodiments, the vehicle visor hinge 200 may be on the top right side of the sun screen 100.

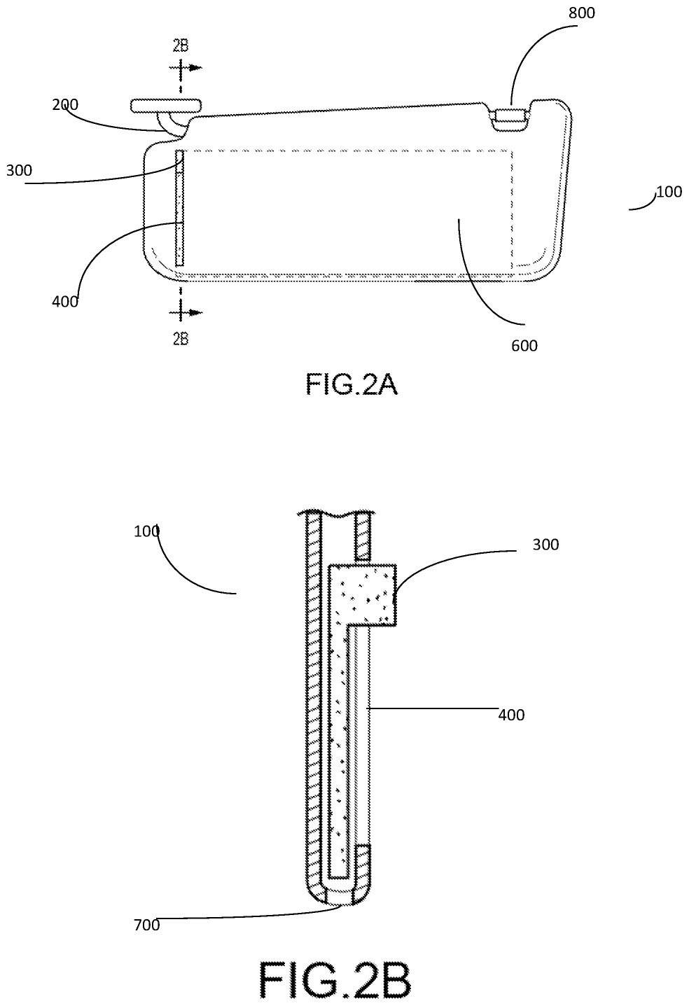

In various embodiments, manual operation tab 300 may be a protrusion on a horizontal retractable panel or on a vertical retractable panel 600 that protrudes through a manual operation tab slot 400, as illustrated in FIG. 2B. In various embodiments, when a manual operation tab 300 is moved through the manual operation tab slot 400, the vertical retractable panel 600 moves. Referring to FIG. 2B, when the vertical retractable panel 600 is retracted, it is fully enveloped in the sun screen 100. In various embodiments, the manual operation tab may be moved to fully or partially extend or retract the horizontal retractable panel. In other embodiments, the manual operation tab 300 may be moved to fully or partially extend or retract a vertical retractable screen.

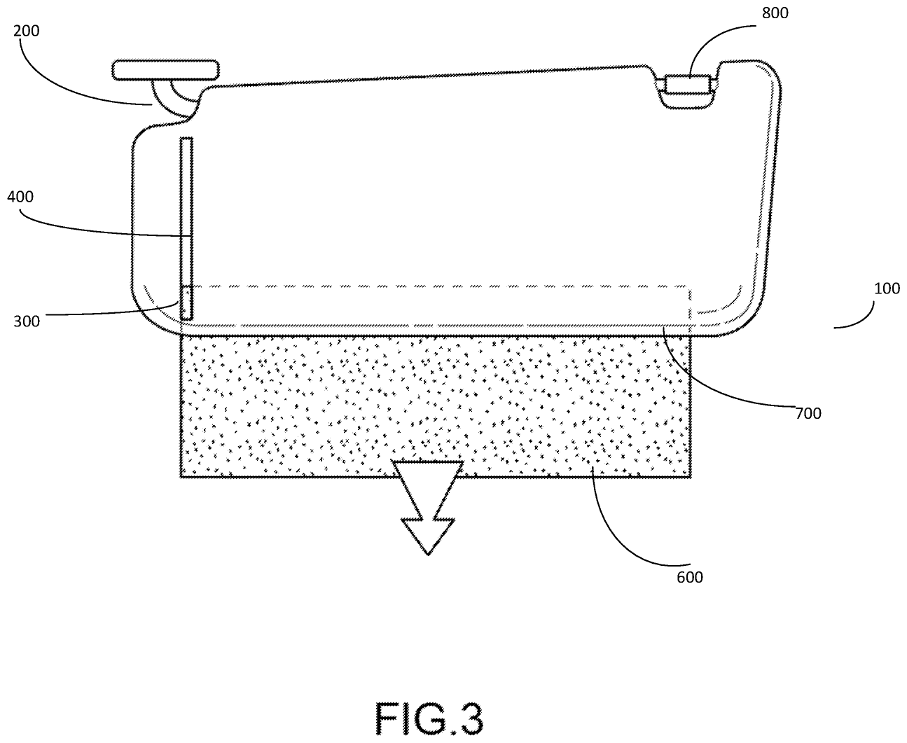

The manual operation tab slot 400 may be a horizontal or vertical channel in the sun screen 100 that allows the manual operation tab to protrude from the inner layer 1900. The vertical channel embodiment is illustrated in FIG. 3, wherein a vertical retractable panel 600 is shown in the fully extended position when the manual operation tab 300 is at the very bottom of the vertical manual operation tab slot 400. In various embodiments, the manual operation tab slot 400 may be on the left side 1800 of the sun screen 100. In various other embodiments, the manual operation tab slot 400 may be on the right side 1700 of the sun screen 100. In various embodiments, the manual operation tab slot 400 may be on the upper 1500 of the sun screen 100. In various embodiments, the manual operation tab slot 400 may be on the lower portion 1600 of the sun screen 100.

In various embodiments, a horizontal retractable panel may extend from the right side 1700 or the left side 1800 of the sun screen 100. In various embodiments, the horizontal retractable panel may be enabled to extend from the right side 1700 and the left side 1800. In various embodiments, the horizontal retractable panel is extended by moving the manual operation tab 300 horizontally through the manual operation tab slot 400. In various embodiments, the horizontal retractable panel may be made of a transparent material. In various embodiments, the horizontal retractable panel may be made of a tinted or polarized material. In various embodiments, the horizontal retractable panel may be made of one or more materials.

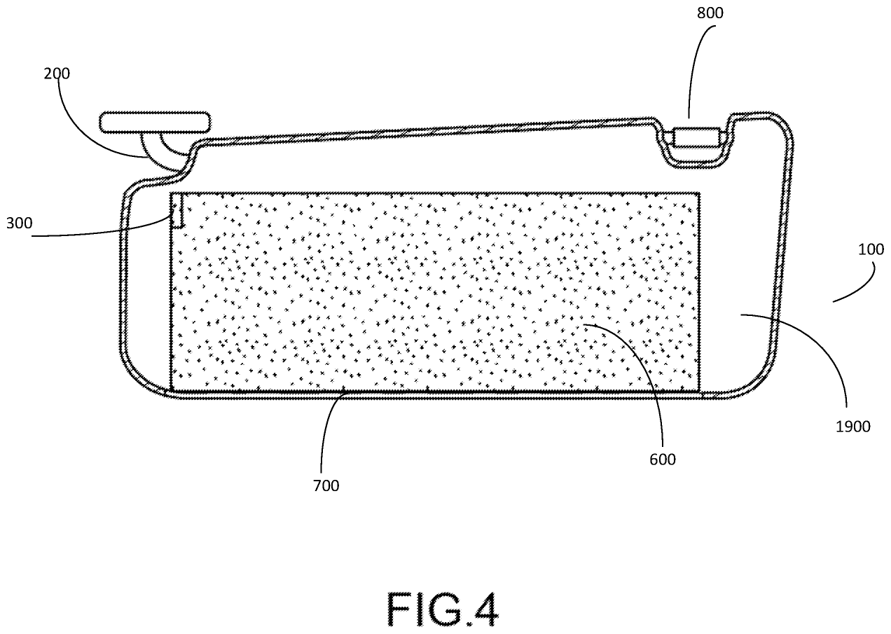

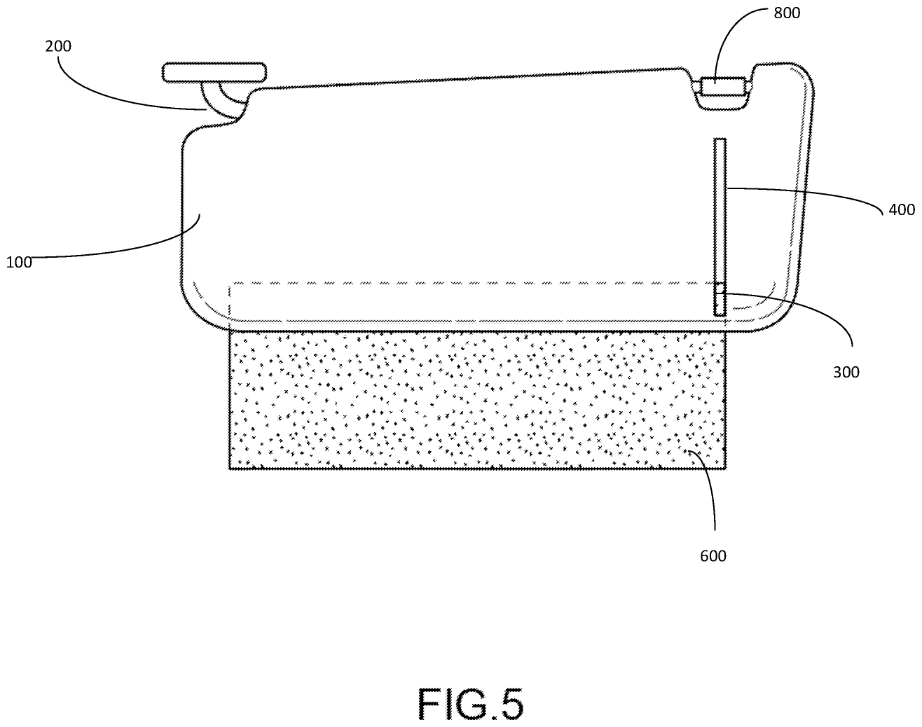

Vertical retractable panel 600 extends from the top or the bottom of the sun screen 100. Referring to FIG. 4, an inner view of the sun screen 100 shows the retracted position of the vertical retractable panel 600. In various embodiments, the vertical retractable panel 600 may be enabled to extend from the right side 1700 and the left side 1800. In various embodiments, the vertical retractable panel 600 is extended by moving the manual operation tab 300 horizontally through the manual operation tab slot 400. In various embodiments, the vertical retractable panel 600 may be made of a transparent material. In various embodiments, the vertical retractable panel 600 may be made of a tinted or polarized material. In various embodiments, the vertical retractable panel 600 may be made of one or more materials. Panels of sun screen 100 may comprise any suitable anti-glare material. For example, panels may comprise tinted polycarbonate materials, polarized materials or coatings, tinted tempered polarized glass, and/or the like.

The screen slot 700 may be an opening in which the vertical retractable panel 600 or horizontal retractable panel may be stowed when retracted. The screen slot 700 is visible in FIG. 2B, a profile view of the sun screen 100. When the vertical retractable panel 600 or horizontal retractable panel is moved into an extended position, the vertical retractable panel 600 or horizontal retractable panel may emerge through the screen slot 700. In various embodiments, the screen slot may be on the bottom of the sun screen 100. In various embodiments, the screen slot 700 may be on the right side 1700 or left side 1800 of the sun screen 100.

In various embodiments, the sun screen 100 may also have a vehicle-visor stowing clip 800. The vehicle-visor stowing clip 800 may removably couple to a clipping element on the vehicle. The vehicle-visor stowing clip 800 may enable the sun screen 100 to move about the axis extending from the vehicle-visor stowing clip 800 and the vehicle-visor hinge 200 when the vehicle-visor stowing clip is coupled to the clipping element on the vehicle.

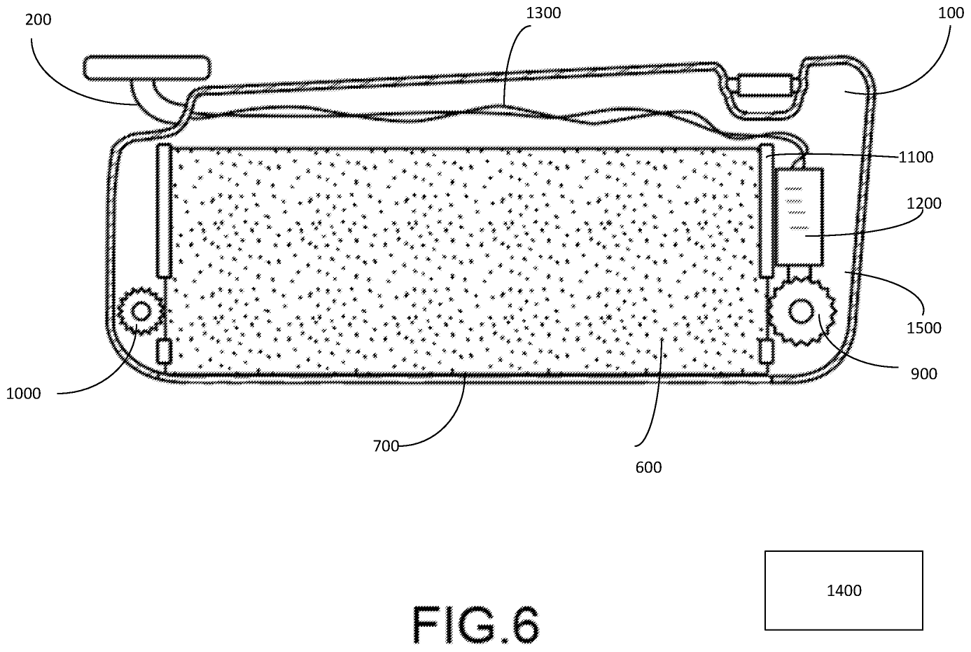

The sun screen 100 may further comprise a first gear 900, a second gear 1000, a bracket 1100, a motor 1200, and wiring 1300. Referring to the embodiment illustrated in FIG. 6, these elements may make up an automation system 1500 wherein the automation system 1500 may function to extend or retract the vertical retractable panel 600 or the horizontal retractable panel without the use of the manual operation tab 300 or any manual activation of the vehicle visor. The first gear 900 and the second gear 1000 may interface with the vertical retractable panel 600 or the horizontal retractable panel to enable the movement of the vertical retractable panel 600 or the horizontal retractable panel. The first gear 900 may mechanically interact with the vertical retractable panel 600 or the horizontal retractable panel and the second gear 1000 may be on a second side 1700 of the vertical retractable panel 600. In various embodiments, the first gear 900 and second gear 1000 may interface with grooves on the vertical retractable panel 600 or the horizontal retractable panel to enable linear movement. In various embodiments, the sun screen 100 with an automation system 1500 may further comprise a manual operation tab 300 and manual operation tab slot for alternate activation of movement of the vertical retractable panel 600 or the horizontal retractable panel. In various embodiments, a bracket 1100 may couple a motor 1200 to the sun screen 100. In various embodiments, wiring 1300 may electrically couple the motor 1200 and the vehicle's electric system to power the motor 1200. In various embodiments, the motor 1200 may be battery powered.

In various embodiments, the automation system 1500 may be activated to extend or retract the vertical retractable panel 600 or the horizontal retractable panel using a control 1400. The control 1400 may be a button on the sun screen 100. The control may be a remote activation device, such as a key fob, phone activation, or button integrated into the interior of a vehicle.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A sun screen, comprising:
a mechanism for coupling the sun screen to a vehicle; and
a first retractable panel of anti-glare material, wherein the first retractable panel is extendable and retractable to provide glare reduction for a vehicle user.

2. The sun screen of claim 1, wherein the sun screen is configured to couple to the sun visor of an existing automobile.

3. The sun screen of claim 1, wherein the sun screen comprises a portion of an original equipment sun visor for a vehicle.

4. The sun screen of claim 1, further comprising a second retractable panel that is extendable and retractable to provide glare reduction for a vehicle user.

5. The sun screen of claim 4, wherein the first retractable panel and the second retractable panel are extendable in a common direction.

6. The sun screen of claim 4, wherein the first retractable panel and the second retractable panel are extendable in different directions.

7. The sun screen of claim 4, wherein the first retractable panel and the second retractable panel at least partially overlap when in a retracted position.

8. The sun screen of claim 1, wherein the first retractable panel is made of a transparent material.

9. The sun screen of claim 1, wherein the first retractable panel is made of a polarized material.

10. The sun screen of claim 1, further comprising one or more motors coupled to the first retractable panel and the second retractable panel to extend and retract the first retractable panel and the second retractable panel.

11. A system for reducing glare in a vehicle, comprising:
a hinged sun screen coupled to a vehicle;
a horizontal retractable panel coupled to the hinged sun screen;
a vertical retractable panel coupled to the hinged sun screen; and
a mechanism for extending and retracting the horizontal retractable panel and the vertical retractable panel manually, wherein the mechanism for extending and retracting can be manually activated to move the horizontal retractable panel and the vertical retractable panel to a position to reduce glare in a vehicle.

12. The system of claim 11, further comprising an automated mechanism for moving the horizontal retractable panel and the vertical retractable panel.

13. The system of claim 12, further comprising a remote control to remotely activate the automated mechanism.

14. The system of claim 13, wherein the remote control is integrated into a vehicle interior.

15. The system of claim 11, wherein the mechanism for extending and retracting the vertical retractable panel is a manual operation tab coupled to the vertical retractable panel that moves the vertical retractable panel.

16. A method of using a sun screen, comprising:
coupling a sun screen to a vehicle;
positioning the sun screen to reduce light that may cause glare in a vehicle;
extending a first retractable panel with non-glare properties from within the sun screen; and
retracting the first retractable panel when the first retractable panel is not desired.

17. The method of claim 16, wherein the retractable panel is extended and retracted using an automated system.

18. The method of claim 17, wherein the automated system is activated using a remote control.

19. The method of claim 16, further comprising extending a second retractable panel.

20. The method of claim 19, wherein the first retractable panel and second retractable panel overlap when retracted.
